(19) United States
(12) Patent Application Publication
(10) Pub. No.: US 2021/0040792 A1
(43) Pub. Date: Feb. 11, 2021

(54) MODULAR LOCKING CURTAIN PARTITIONS

(71) Applicant: Rite-Hite Holding Corporation, Milwaukee, WI (US)

(72) Inventors: Charles J. Ashelin, Dubuque, IA (US); David J. Hoffmann, Peosta, IA (US); Frank Heim, Platteville, WI (US); Kelly Allen, Peosta, IA (US); Timothy J. Schmidt, Dubuque, IA (US)

(21) Appl. No.: 16/988,462

(22) Filed: Aug. 7, 2020

Related U.S. Application Data
(60) Provisional application No. 62/884,041, filed on Aug. 7, 2019.

(51) Int. Cl. E06B 9/262; E06B 9/36; E05C 9/04

(52) U.S. Cl. CPC E06B 9/262; E05C 9/042; E06B 9/362

(57) ABSTRACT

Example room partitions are disclosed. An example room partition includes a plurality of poles to be suspended from a track. A curtain assembly has a plurality of sleeves through which the plurality of poles extends. The curtain assembly has a lowermost edge. An upper lock pin is attached to an upper end of a first pole of the plurality of poles and is movable between a raised lock position and a lowered unlock position relative to the first pole, the upper lock pin to be restrained when the upper lock pin is in the raised lock position, the upper lock pin to be unrestrained when the upper lock pin is in the lowered unlock position. A lower lock pin is attached to a lower end of the first pole and is movable between a descended lock position and an elevated unlock position relative to the first pole. The lower lock pin is to extend lower than the lowermost edge of the curtain assembly when the lower lock pin is in the descended lock position. The lower lock pin is to be above the lowermost edge of the curtain assembly when the lower lock pin is in the elevated unlock position.

### RELATED APPLICATION

This patent claims the benefit under 35 U.S.C. § 119(e) of U.S. Provisional Patent Application Ser. No. 62/884,041 entitled, “Modular Locking Curtain Partitions,” which was filed on Aug. 7, 2019, and is hereby incorporated by reference in its entirety.

### FIELD OF THE DISCLOSURE

This disclosure relates generally to curtain partitions for use as room dividers and, more particularly, to modular locking curtain partitions.

### BACKGROUND

Curtain partitions typically include one or more layers of fabric or flexible sheet material hung from a ceiling, or some other overhead structure, to divide a room or open space within a building into separate zones. Compared to permanent rigid walls, curtain partitions are usually less expensive to install and easier to reconfigure when adapting a space to changing spatial and functional needs.

In temperature-controlled or sound-isolating applications, a curtain partition may include a core of insulation for reducing (e.g., minimizing) heat or sound transfer between adjacent zones. Typical insulation is a pad of batting or foam. Insulated partitions usually have an outer layer of flexible sheet material to contain and protect the less durable core of insulation.

### BRIEF DESCRIPTION OF THE DRAWINGS

FIG. 1 is a front view of an example room partition constructed in accordance with the teachings disclosed herein shown in an unlocked configuration.

FIG. 2 is a front view of the room partition shown in FIG. 1, shown in a locked configuration.

FIG. 3 is an exploded front view of an example curtain assembly disclosed herein.

FIG. 4 is a front view of an example curtain assembly disclosed herein.

FIG. 5 is an exploded top view of various example curtain assemblies disclosed herein.

FIG. 6 is a top view of one example curtain assembly shown in FIG. 5.

FIG. 7 is a top view of another example curtain assembly shown in FIG. 5.

FIG. 8 is a top view of yet another example curtain assembly shown in FIG. 5.

FIG. 9 is a side view of an example pole disclosed herein shown in an unlocked configuration.

FIG. 10 is a cross-sectional view taken along line 10-10 of FIG. 9.

FIG. 11 is a side view of the example pole shown in FIG. 9 but shown in a locked configuration.

FIG. 12 is a cross-sectional view taken along line 12-12 of FIG. 11.

FIG. 13 is a front view of another example pole disclosed herein shown in an unlocked configuration.

FIG. 14 is a front view of the example pole shown in FIG. 13 but shown in a locked configuration.

FIG. 15 is a front view of an example sleeve module disclosed herein that includes the example pole of FIG. 13 in an unlocked configuration.

FIG. 16 is a front view of the example sleeve module shown in FIG. 15 but with the example pole of FIG. 14 in a locked configuration.

FIG. 17 is a side view of another example pole disclosed herein shown in an unlocked configuration.

FIG. 18 is a side view of the example pole shown in FIG. 17 shown in a locked configuration.

FIG. 19 is a cross-sectional view of the example sleeve module of FIG. 15 taken along line 19-19 of FIG. 15.

FIG. 20 is a top view of example curtain modules detached from the example sleeve module of FIG. 19.

FIG. 21 is a top view similar to FIG. 20 but showing the example sleeve module of FIG. 19 attached to the example curtain modules.

FIG. 22 is a top view of an example curtain module disclosed herein.

FIG. 23 is a front view of the example curtain module of FIG. 22.

FIG. 24 is a front view of an example curtain assembly disclosed herein shown in a first configuration.

FIG. 25 is a front view of the example curtain assembly shown in FIG. 24 but showing the curtain assembly in another configuration.

FIG. 26 is a front view of the example curtain assembly of FIGS. 24 and 25 but showing the example curtain assembly in yet another configuration.

FIG. 27 is a back view of an example curtain assembly disclosed herein.

FIG. 28 is a back view similar to FIG. 27 but showing a person reaching through an access opening of the example curtain assembly.

FIG. 29 is a front view of an example curtain assembly disclosed herein shown in an expanded configuration.

FIG. 30 is a front view similar to FIG. 29 but showing the example curtain assembly in a compact or stored configuration.

### DETAILED DESCRIPTION

Example room partitions disclosed herein include an interconnected series of curtain modules and sleeve modules assembled in an alternating arrangement to create a curtain assembly. The curtain assembly can be attached to (e.g., hung from) a track. The track can be installed with the installation of the curtain assembly or the track can be an existing structure. To provide the curtain assembly with rigidity and resistance to air pressure differentials, each sleeve module includes (e.g., contains) a relatively rigid pole with upper and lower locks. The upper lock is movable between a release position (e.g., a lowered unlock position) and a lock position (e.g., a raised lock position). The upper lock moves between the release position and the lock position to engage or release a catch or a hole or some other discontinuity in the track. The lower lock is movable between a release position (e.g., an elevated unlock position) and a locked position (e.g., a descended lock position). The lower lock moves between the release position and the locked position to engage or disengage (e.g., release) a catch or a hole located in the floor.

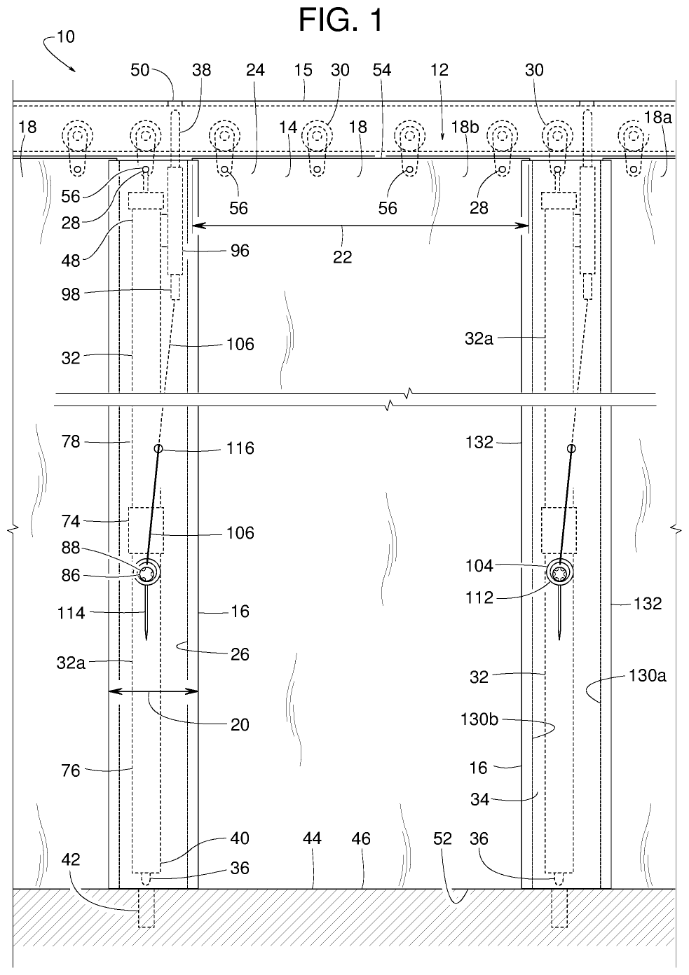

FIGS. 1-28 show examples of a room partition 10 including a curtain assembly 12, and components thereof. The curtain assembly 12 of the illustrated example is coupled to (e.g., hanging from) a track 15. The track 15 can be installed during installation of the curtain assembly 12 or the track 15 can be an existing structure of a building or other structure. Some examples of curtain assembly 12 are made of a pliable sheet material 14 (e.g., polyester, vinyl, fabric, cloth, rubber, etc., and various combinations thereof). The term, “pliable” refers to a material that can be folded over onto itself and then unfolded without permanent deformation to the material.

In some examples, curtain assembly 12 includes one or more sleeve modules 16 interconnecting one or more curtain modules 18 (e.g., curtain modules 18a, 18b, etc.). In some examples, a plurality of curtain 18 and sleeve modules 16 can be assembled in an alternating arrangement. The term, “alternating arrangement” means that each sleeve module 16 of a given plurality of sleeve modules 16 is interposed between (e.g., two) curtain modules 18. In other examples, curtain modules 18 and sleeve modules 16 can be assembled in other arrangements.

In the illustrated examples, each sleeve module 16 has a sleeve width 20 that is less than a curtain width 22 of curtain module 18. Sleeve module 16 is a component that has multiple features while being relatively narrow, which makes the sleeve module 16 economical to store in inventory as a modular component. Curtain module 18 is generally simpler in construction (fewer features) while being relatively wider, which makes curtain module 18 suitable for storing in bulk and/or cutting to size and/or sewing or altering on an as-needed basis. In some examples, curtain module 18 includes a curtain 24 (e.g., made of sheet material 14) with one or more releasable fasteners 26 along its (e.g., vertical) edges for releasably connecting to corresponding (e.g., vertical) edges of sleeve module 16. Curtain module 18 can also include a row of connection points or fixtures 28 (e.g., grommets) along its upper (e.g., horizontal) edge where the curtain module 18 is coupled to a plurality of trolleys 30 on track 15.

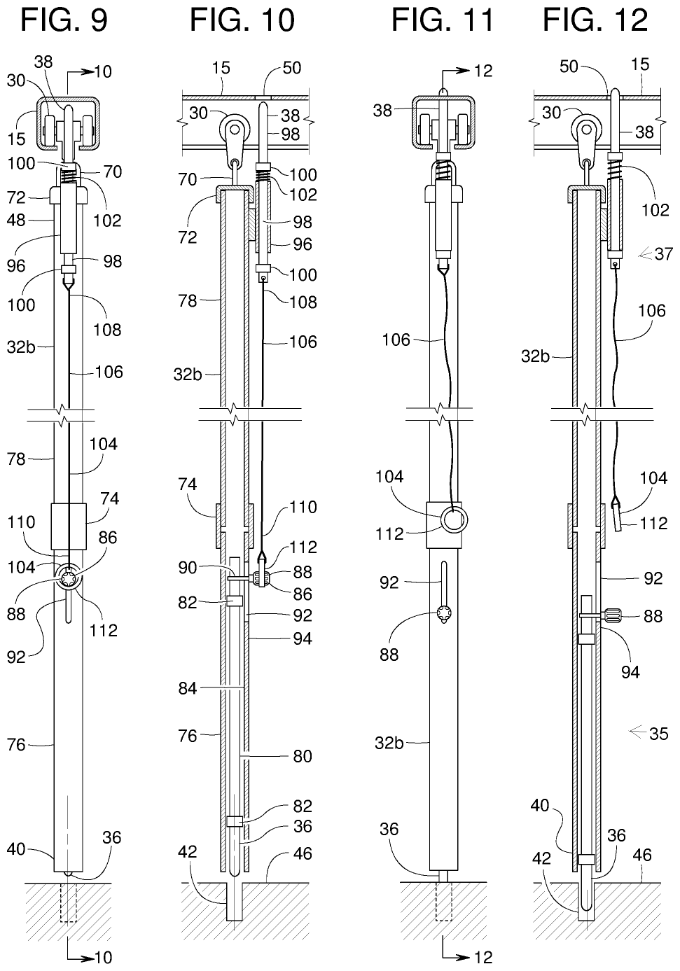

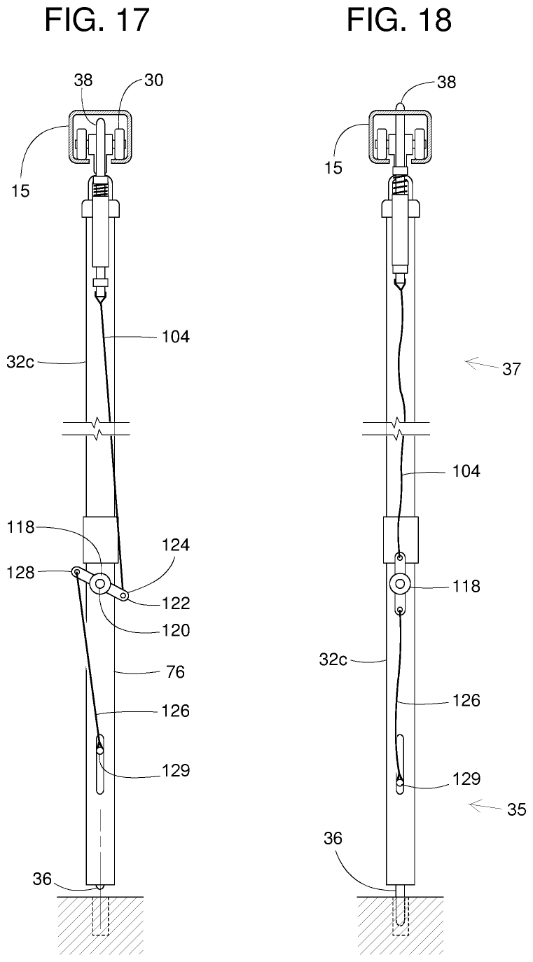

To provide curtain assembly 12 with structural support (e.g., suitable rigidity and resistance to air pressure differentials), each sleeve module 16 includes or is configured to receive a relatively rigid pole 32 (e.g., pole 32a of FIGS. 1, 2 and 13-16; pole 32b of FIGS. 9-12; or pole 32c of FIGS. 17 and 18) disposed within a sleeve 34 of pliable sheet material 14. Some examples of sleeve modules 16 include one or more connection points or fixtures 28 (e.g., grommets) at/along its upper (e.g., horizontal) edge where the sleeve module 16 is coupled to one or more trolleys 30 on track 15. In some examples, pole 32 is made of metal, but it may also be made of fiberglass, rigid plastic (e.g., PVC), or other suitable material and/or combination of materials to provide support for the pliable sheet material 14.

Some examples of pole 32 include a lower lock 35, which may include a lower lock pin 36, and/or an upper lock 37, which may include an upper lock pin 38. While various types of locks can be implemented, the following structural and functional description pertains to examples such as those illustrated in the figures. Lower lock pin 36 can be (e.g., vertically) movable to selectively secure or release a lower end 40 of pole 32 relative to a discontinuity 42 (e.g., a first discontinuity, a plurality of discontinuities, a hole, a groove, a notch, a tooth, etc.) in/on an upper surface 44 of a floor 46 (as shown in FIG. 1) and/or in/on a track connected to the floor 46 (not shown). Upper lock pin 38 of pole 32 can be (e.g., vertically) movable to selectively secure or release an upper end 48 of pole 32 relative to a discontinuity 50 (e.g., a first discontinuity, a plurality of discontinuities, a hole, a groove, a notch, a tooth, etc.) in track 15. Some examples of track 15 (or a track connected to the floor 46) include a C-channel, an elongate member of some other cross-sectional shape, a beam, a bar, and/or a cable. In some examples, track 15 is directly or indirectly mounted to an overhead structure, such as a ceiling, a truss, a beam, etc.

In the illustrated examples, trolleys 30 couple poles 32 to track 15 such that sleeve modules 16, and curtain modules 18 by connection thereto, are repositionable along the length of track 15 when lock pins 36 and 38 are in their respective release positions. Accordingly, curtain assembly 12, as a whole or sections thereof, can be moved (e.g., horizontally) along track 15. FIG. 1, for instance, shows upper lock pins 38 descended to a lowered, unlocked position, disengaged from the track's discontinuities 50. FIG. 1 also shows lower lock pins 36 raised to an elevated, unlocked position above a lowermost edge 52 of curtain assembly 12, disengaged from discontinuities 42 in floor 46. With lock pins 38, 36 free of discontinuities 50, 42, respectively, the curtain assembly 12, including at least two sleeve modules 16 and at least three curtain modules 18, can be moved (e.g., horizontally) along track 15.

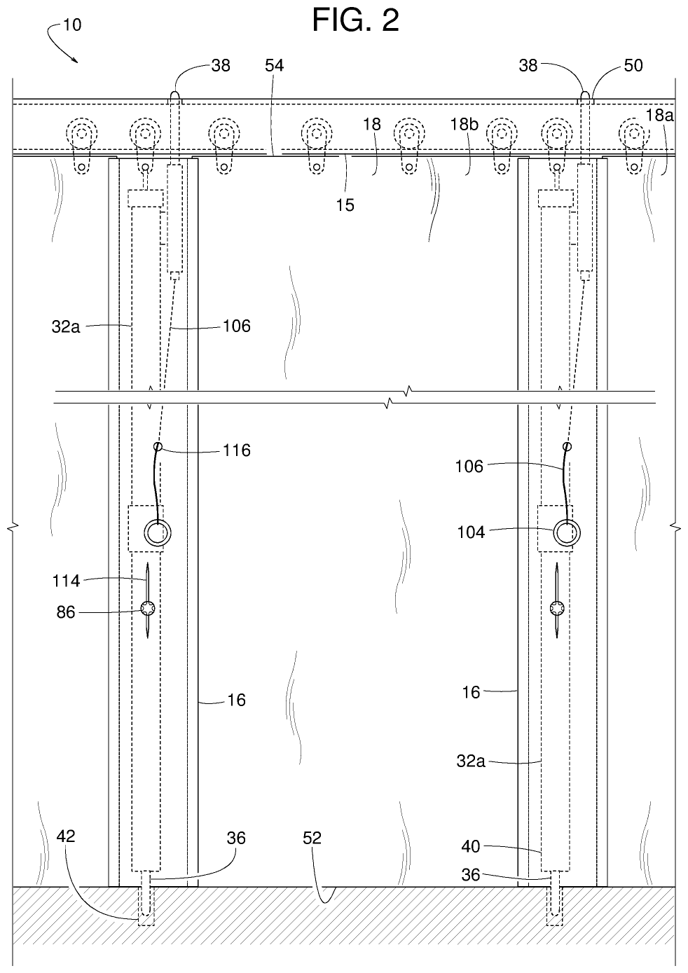

Conversely, FIG. 2 shows upper lock pins 38 moved (e.g., upward) to a raised, lock position where upper lock pins 38 are restrained by (e.g., engaged with) discontinuities 50 in track 15, while lower lock pins 36 are shown moved (e.g., downward) to a lowered, lock position where lower lock pins 36 are restrained by (e.g., engaged with) discontinuities (i.e., holes) 42 in floor 46. With lock pins 38 and 36 restrained by discontinuities 50 and 42, respectively, curtain assembly 12 is locked in place relative to track 15 and floor 46 (i.e., the curtain assembly 12 cannot move along track 15).

Upper locks 37 are particularly useful in securing curtain assembly 12 from billowing or other unintentional movement. More specifically, when engaged with track 15 (i.e., locked), upper lock pins 38 restrain adjacent sections of the curtain assembly's upper edge 54 from moving/shifting (e.g., horizontally) along or transversely to track 15 in reaction to air pressure differentials or other forces applied to the face of curtain assembly 12.

In some examples, sleeve modules 16 and curtain modules 18 include connection points 28 along upper edge 54 of curtain assembly 12. To suspend curtain assembly 12 from track 15, fasteners 56 couple trolleys 30 to connection points or fixtures 28 on the sleeve modules 16 and curtain modules 18. Fasteners 56 are schematically illustrated to represent any component or assembly to couple curtain assembly 12 to trolleys 30. Some examples of fasteners 56 include chain links, carabiners, hooks, loops, snaps, nuts and bolts, etc., and/or various combinations thereof.

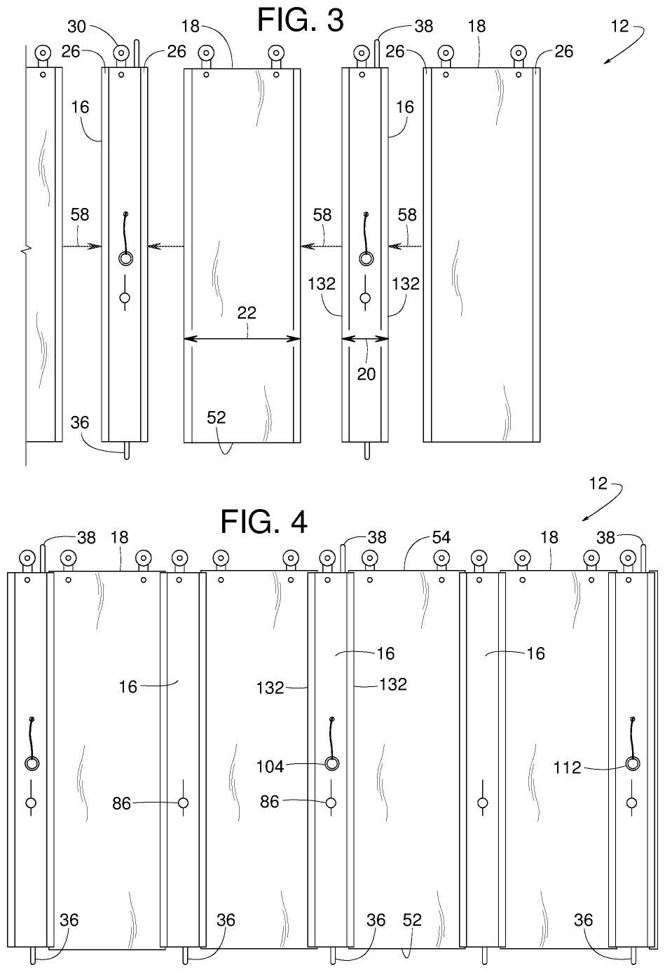

FIGS. 3-8 show how the modularity of curtain modules 18 and sleeve modules 16 allow curtain assembly 12 to be readily assembled in various configurations. Arrows 58 of FIG. 3 represent how modules 16 and 18 can be assembled in an alternating arrangement to create an example curtain assembly 12 including, in this example, two sleeve modules 16 and at least three curtain modules 18. FIG. 4 shows curtain assembly 12 having five sleeve modules 16 interconnecting four curtain modules 18. Other examples of curtain assembly 12 comprise any number of sleeve modules 16 and curtain modules 18 in any arrangement.

In some examples, the curtain assembly 12 may be sufficiently restrained from unintended movement without requiring as many securing structures (i.e., locks) at the upper edge 54 as the lowermost edge 52. For example, as shown in FIG. 4, curtain assembly 12 has fewer upper locks 37 (three) than lower locks 35 (five). Having fewer upper locks 38 can simplify the processes of locking the curtain assembly 12 in place, unlocking the curtain assembly, and/or moving it.

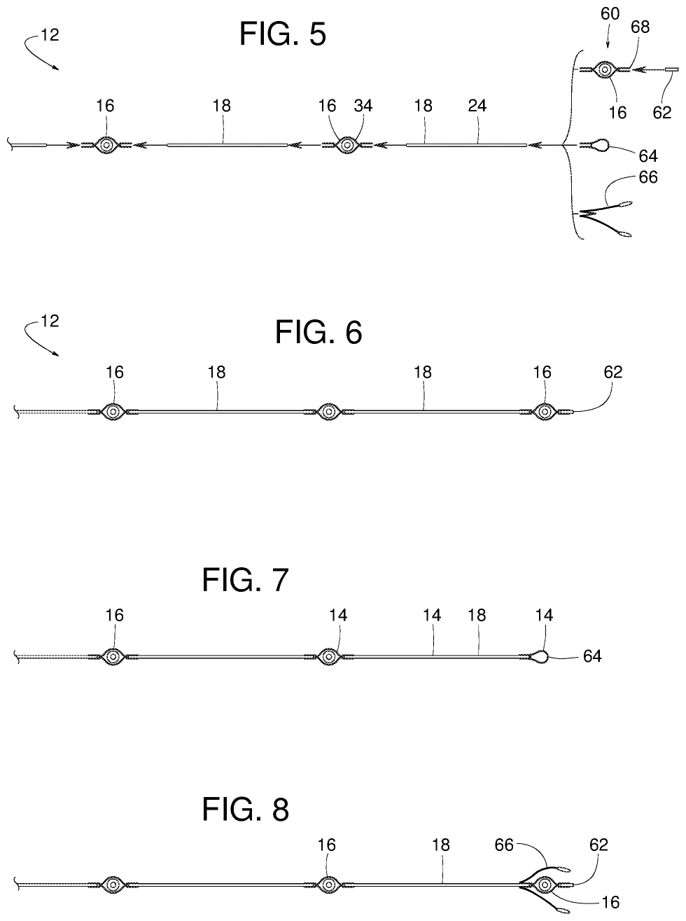

FIG. 5 is an exploded top view of FIG. 3 also showing an assortment of accessories 60 that can be added or coupled, individually or in various combinations, to an end of curtain module 18 on one end of example curtain assembly 12. Some examples of accessories 60 include an additional sleeve module 16, a filler strip 62, a (e.g., vertically) elongate seal 64, and a tie-back 66. In some examples, curtain assembly 12 ends with a sleeve module 16 rather than a curtain module 18. Accordingly, accessories 60 can be adapted to be connected thereto. For example, as illustrated in FIG. 6, filler strip 62 fills an otherwise open, unconnected edge 68 of the end sleeve module 16 of a given curtain assembly 12. However, the filler strip 62 can also provide a finished edge to a curtain module 18 at the end of a curtain assembly 12 without a sleeve module 16 positioned therebetween.

Seal 64, in some examples, includes a (e.g., vertically) elongate strip of flexible sheet material curved about a (e.g., vertical) axis to create a hollow loop, or bulb seal, as shown in FIG. 7. In some examples, the seal 64 or material of the seal 64 may have elastic properties and/or be resiliently compressible and/or deformable. Seal 64 can provide curtain assembly 12 with a (e.g., vertical) sealing edge suitable for maintaining contact with a wall, other structure, the edge of another curtain assembly 12, or other barrier. In some examples, seal 64, sleeve 34, and curtain 24 are each made of the same or substantially equivalent pliable sheet material 14 for simplifying manufacturing, reducing costs, and creating a consistent overall appearance of the curtain assembly 12.

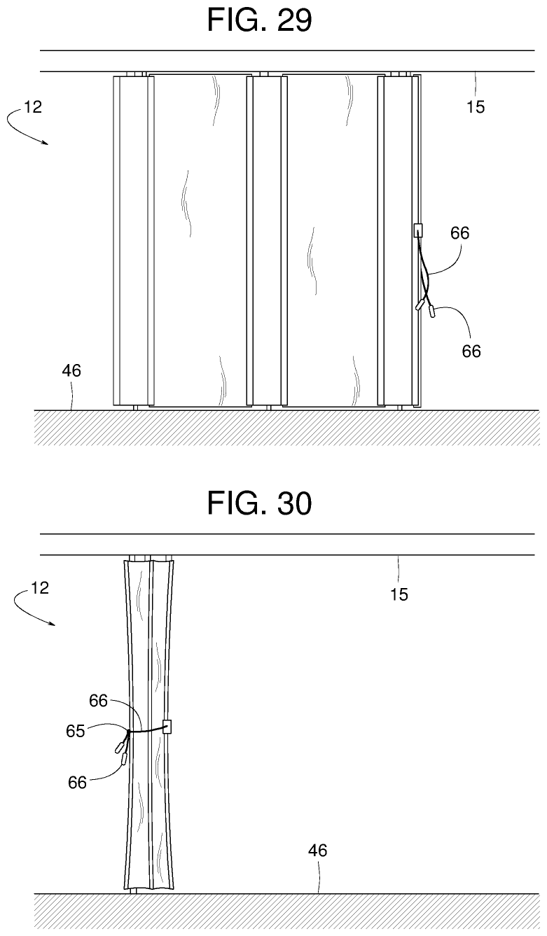

Tie-back 66 can be used for restraining curtain assembly 12 for storage when in a retracted configuration, reducing (e.g., minimizing) the (e.g., horizontal) width of the curtain assembly 12, as shown in FIG. 30. Tie-back 66 can also be used for moving (e.g., pulling) curtain assembly 12 along track 15 between an expanded configuration, as shown in FIG. 29 and the retracted configuration. Consequently, tie-back 66 is schematically illustrated to represent any suitable means for assisting a user in manually gripping, applying force, and/or thereby repositioning curtain assembly 12 along track 15 and/or for restraining curtain assembly 12 when in a retracted configuration. Some examples of tie-back 66 include a rope, a strap, a chain, a cable, a handle, and/or various combinations thereof, etc. Some examples of tie-back 66, as shown in FIGS. 5, 8, 29 and 30, come as a pair that can be coupled to each other at a connection point 65 adjacent the opposite (e.g., vertical) edge from where they are coupled to the curtain assembly 12.

FIGS. 9-12 show pole 32b suspended from track 15. Sleeve 34 is not shown so as to more clearly illustrate some structural details of pole 32b, upper lock 37 and lower lock 35. FIGS. 9 and 10 show lock pins 38 and 36 disengaged and free from their respective discontinuity 50, 42. FIGS. 11 and 12 show upper lock pin 38 restrained by discontinuity 50 in track 15 and lower lock pin 36 restrained by discontinuity (i.e., hole) 42 in floor 46.

In this illustrated example, track 15 is in the shape of a C-channel with discontinuities 50 being a series of holes through an upper portion of the track 15. Trolley 30, in this example, rolls along the inner surface of track 15. A link 70 connects trolley 30 to a cap 72 on upper end 48 of pole 32b. In this example, pole 32b includes a coupling 74 connecting a lower tube portion 76 to an upper tube portion 78. In some examples, lower portion 76 is of a given standard length, while upper portion 78 is selected from an assortment of tube portions of various lengths to make pole 32b any desired overall length.

In some examples, pole 32 includes lower lock 35 and/or upper lock 37 which can each be selectively operated (e.g., by a user) to a locked position to secure the respective lower and upper portions of the curtain assembly 12 from movement or an unlock position to enable movement of the curtain assembly 12. In some examples, the lower lock 35 and/or upper lock 37 may have a usual (i.e., default or initial) state. The usual state for each lock is the state in which it exists without force applied by a user. In the example of FIGS. 9-16, lower lock 35 includes a rod 80 terminating in lower lock pin 36 with one or more collars 82 along its length that guide rod 80 axially (e.g., vertically) in sliding contact with an inner surface 84 of lower tube portion 76. The sliding fit enables rod 80 to move lower lock pin 36 between an elevated unlocked position (FIGS. 9 and 10) and a descended locked position (FIGS. 11 and 12).

Some examples of lower lock 35 include a lower lock actuator 86 that enables a user to (e.g., manually) move lower lock pin 36 between a locked position and an unlocked position. In some examples, lower lock actuator 86 includes a fixture such as a knob 88 at the end of a screw 90. Screw 90 extends through a slot 92 in lower tube 76 and screws into a threaded hole in the upper end of rod 80. When lower lock pin 36 is in the elevated unlocked position, knob 88 can be turned (e.g., manually) in first or clockwise direction to tighten screw 90 into rod 80 and move knob 88 into contact with an outer surface 94 of lower tube portion 76, thereby frictionally holding lower lock pin 36 at the elevated unlocked position (i.e., lower lock 35 in the unlocked state). To move lower lock pin 36 to the descended lock position, knob 88 can be turned in a second or counterclockwise direction, which releases the frictional holding forces of screw 90 to allow rod 80 to move (e.g., fall by gravity and/or by manual force, via the lower actuator along the slot 92) into discontinuity 42 in floor 46 (i.e., lower lock 35 in the locked state). Accordingly, the usual state of lower lock 35 in the example of FIGS. 9-16 is a locked state because gravitational force biases the lower lock 35 into a locked state. To move lower lock 35 from the locked state to the unlocked state, a force (e.g., by a user) is applied to overcome the gravitational force. The unlocked state can be sustained by either a user maintaining the counter-gravitational force, or by securing the lower lock 35 in an unlocked position through engagement with another element of the curtain assembly 12 and/or external structure to maintain the counter-gravitational force. In this example, the pole 32 is engaged by the knob 88 via screw 90. In an alternative example, slot 92 can have a circumferential portion (at a sufficient height) that the screw could be moved into to maintain the lower lock 35 in an unlocked state.

Some examples of upper lock 37 include a cylinder 96 attached to the side of the upper end 48 of upper tube portion 78 with its axis oriented substantially parallel thereto. A rod 98 terminating in upper lock pin 38 is positioned to slide axially (e.g., vertically) within cylinder 96, while one or more collars 100 along the length of rod 98 limit its axial (e.g., vertical) travel within the cylinder 96. In some examples, a bias member 102 (e.g., a compression spring positioned between the cylinder 96 and the collar 100 or an alternative thereof) urges rod 98 upward, thereby biasing upper lock pin 38 to its raised locked position (FIGS. 11 and 12).

As the illustrated example shows, an upper lock actuator 104 can be used for moving upper lock pin 38 down to its lowered unlocked position (FIGS. 9 and 10). Upper lock actuator 104 includes a pliable elongate member 106 (e.g., a rope, a spring, a wire, a cable, a chain, a cord, a strap, etc.) with a first end 108 connected to the lower end of rod 98 and a second end 110 which can terminate at a fixture such as a loop 112 (e.g., a loop portion of member 104, a ring, a short bar, etc.). Pulling (e.g., manually) the pliable elongate member 106 via fixture 112 in first or downward direction, with sufficient force to overcome bias member 102, pulls rod 98 down and upper lock pin 38 out of engagement with discontinuity 50 and moving upper lock pin 38 to its lowered unlocked position (i.e., upper lock 37 into its unlocked state).

In some examples, pliable elongate member 106 has a length which enables fixture (e.g., loop) 112 of upper lock actuator 104 to be connected to the fixture (e.g., knob) 88 of the lower lock actuator 86 under tension (from bias member 102). In some such examples, when lower lock pin 36 is in its elevated unlocked position (FIGS. 9, 10, 13, & 15), the fixture 112 of the upper lock actuator 104 can be secured to fixture 88 of the lower lock actuator 86 to hold upper lock pin 38 in its lowered unlocked position. Accordingly, the usual state of upper lock 37 in the example of FIGS. 9-16, is a locked state because spring force biases the upper lock 37 into a locked state. In order for upper lock 37 to change state from locked to unlocked, a user applies a force to overcome the spring force. The unlocked state can be sustained by either a user maintaining the counter-spring force, or by securing the upper lock 37 in an unlocked position through engagement with another element of the curtain assembly 12 or external structure to maintain the counter-spring force. In this example, the knob 88 or screw 90 is engaged by the loop 112. In an alternative example, pole 32 can have a protuberance (at a sufficient distance from the fixed portions of the upper lock 35) that the fixture 112 could be looped onto (under tension) to maintain the upper lock 35 in an unlocked state.

In some examples, bias member 102 can be selected to impart a net (e.g., upward) force on the movable elements of the upper lock 37 that is comparable (i.e., similar or equal) to the (e.g., downward) force due to gravity on the movable elements of the lower lock 35 such that when connected, the lower lock 35 and upper lock 37 are both maintained in an unlocked state.

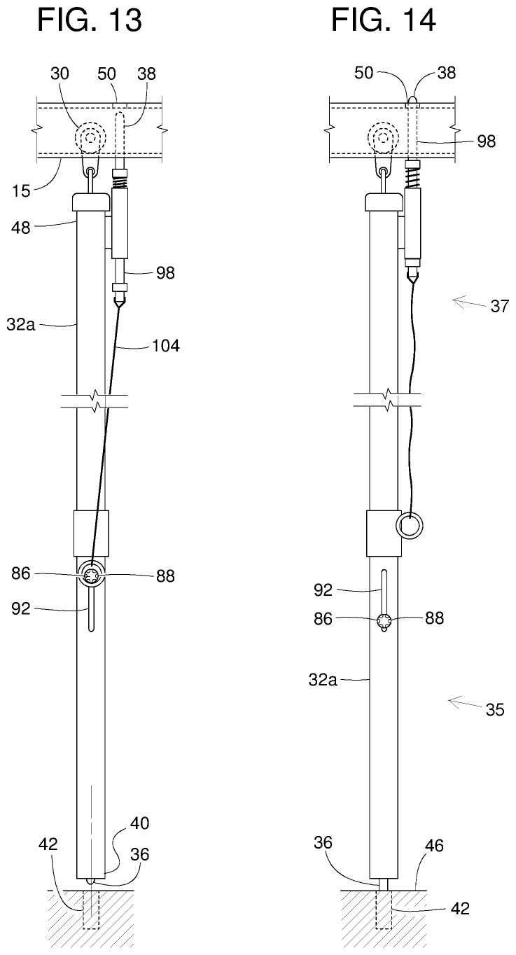

Pole 32a, shown in FIGS. 13-16, is structurally and functionally similar to pole 32b. FIGS. 13 and 14 correspond to FIGS. 10 and 12, respectively. The difference between poles 32a and 32b pertains to the circumferential orientation of lower lock 35 (slot 92, screw 90, and knob 88) relative to upper lock 37 (cylinder 96, rod 98, and upper lock pin 38). In FIGS. 9-12, the lower and upper locks 35, 37 are circumferentially aligned with respect to pole 32b. In other words, knob 88 is directly underneath rod 98, so knob 88 and rod 98 have the same circumferential orientation about the (e.g., vertical) axis of pole 32b. In FIGS. 13-16 however, the lower lock 35 is (e.g., approximately) 90 degrees out of circumferential alignment from the upper lock 37 with respect to the pole 32a—knob 88 is rotated ninety degrees around pole 32a relative to rod 98. The relative circumferential orientation of lower and upper locks 35, 37 on pole 32a is such that upper rod 98 and upper lock pin 38 are (e.g., substantially) centered underneath track 15, while knob 88 is accessible from a face of sleeve module 16 without interference with releasable fastener 26, which extends along the (e.g., vertical) edges of sleeve module 16 and curtain module 18.

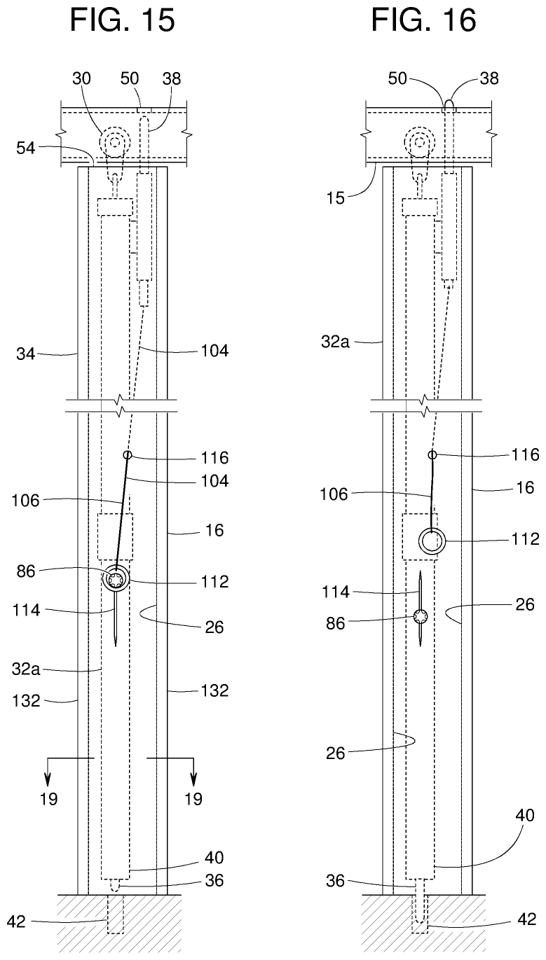

FIGS. 15 and 16 show pole 32a, as illustrated in FIGS. 13 and 14, installed within sleeve 34 to form sleeve module 16 (i.e., sleeve module 16 includes pole 32a and sleeve 34). FIGS. 13 and 15 show pole 32a with lower and upper lock pins 36, 38 free of discontinuities 42, 50 (i.e., lower and upper locks 35, 37 in unlocked state), and FIGS. 14 and 16 show pole 32a with lower and upper lock pins 36, 38 restrained by discontinuities 42, 50 (i.e., lower and upper locks 35, 37 in locked state).

In the example illustrated in FIGS. 15 and 16, knob 88 of lower lock actuator 86 extends through a slit 114 in sleeve 34. Slit 114 allows screw 90 and knob 88 to travel (e.g., vertically) relative to sleeve 34 as rod 80 is moved up and down relative to pole 32a. Sleeve 34 also has a hole 116 through which the elongate member 106 of the upper lock actuator 104 extends. This allows the upper lock actuator 104 to be accessible and operated via fixture 112 from the exterior of sleeve 34, while most of the upper lock 37 components are contained within the sleeve 34. In the illustrated example, slit 114 and hole 116 are on the same side of sleeve 34 to restrict or prevent air from passing through sleeve 34 from one side of the partition 10 to the other (i.e., in a direction substantially perpendicular to the face of curtain 24) and/or to enable operation of both lower and upper locks 35, 37 from one side of the curtain assembly 12. As used herein, “substantially perpendicular” means perfectly perpendicular or almost perfectly perpendicular (e.g., within 10 degrees of perfectly perpendicular).

FIGS. 17 and 18 show alternative examples of fixtures which enable actuation of upper and lower locks 37 and 35. In this example, a common actuator 118 retracts both lock pins 36 and 38 (e.g., simultaneously). Some examples of common actuator 118 include an axle 120 attached to pole 32c with a dual-arm lever 122 mounted for rotation about axle 120. Upper lock actuator 104 connects a first end 124 of lever 122 to upper lock pin 38, and lower lock actuator 86 (including pliable elongate member 126 and pin 129) connects a second end 128 of lever 122 to lower lock pin 36. Rotating lever 122 about axle 120 moves pins 36 and 38 between unlocked (FIG. 17) and locked (FIG. 18) positions.

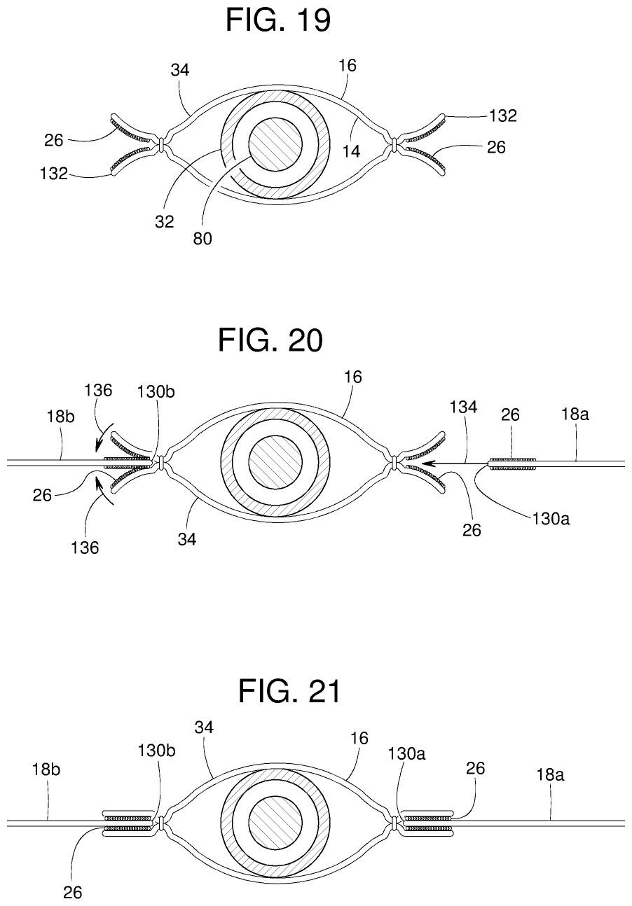

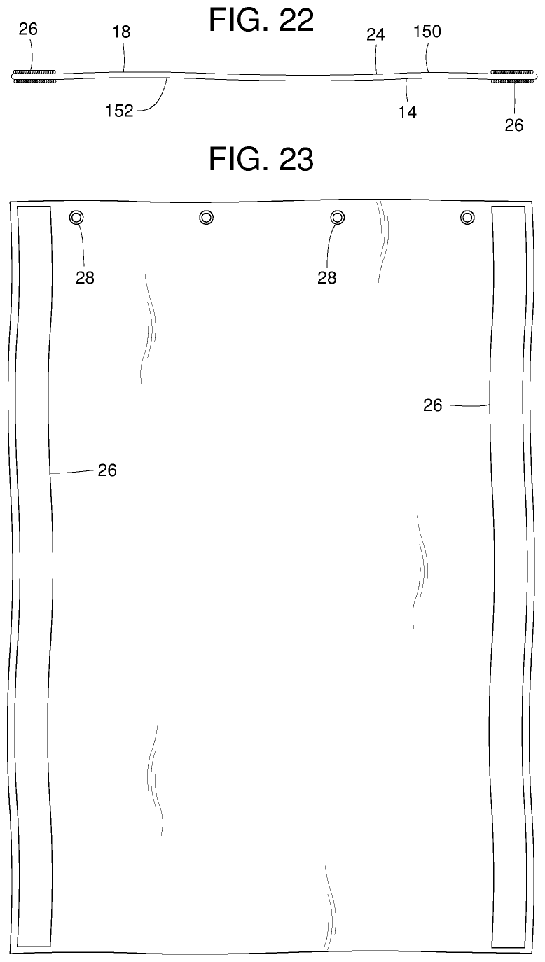

FIGS. 19-23 show various views of releasable fastener 26 that enables sleeve 34 of sleeve module 16 to couple a first connecting edge 130a of first curtain module 18a to a second connecting edge 130b of second curtain module 18b. FIGS. 22 and 23 show an example of curtain modules 18a and 18b comprising a single sheet of curtain 24. Other examples of curtain modules 18a and 18b include multiple sheets of curtain 24 and may also include a layer of thermal insulation sandwiched between the sheets.

The term, “releasable fastener” refers to any structure for selectively joining and separating at least two items without damage. Some examples of releasable fastener 26 include a touch-and-hold fastener, a hook-and-loop fastener, a series of snaps, a series of magnets, a zipper, laces, etc. VELCRO, which is a registered trademark of Velcro Companies of the United Kingdom, is one example of a touch-and-hold fastener and a hook-and-loop fastener.

FIG. 19 shows a part of releasable fastener 26 (e.g., a hook part or a loop part) along each connecting edge 132 of sleeve 34 open to receive the mating parts of connector 26 on the edges 130a and 130b of the curtain modules. Arrow 134 of FIG. 20 represents edge 130a of first curtain module 18a being inserted into position adjacent the portion of releasable fastener 26 on edge 132 of sleeve 34. Arrows 136 of FIG. 20 represent releasable fastener 26 on sleeve 34 being moved into engagement with the portion of releasable fastener 26 on the edge 130b of second curtain module 18b. FIG. 21 shows releasable fastener 26 along each edge 132 of sleeve 34 coupling first edge 130a of first curtain module 18a to second edge 130b of second curtain module 18b.

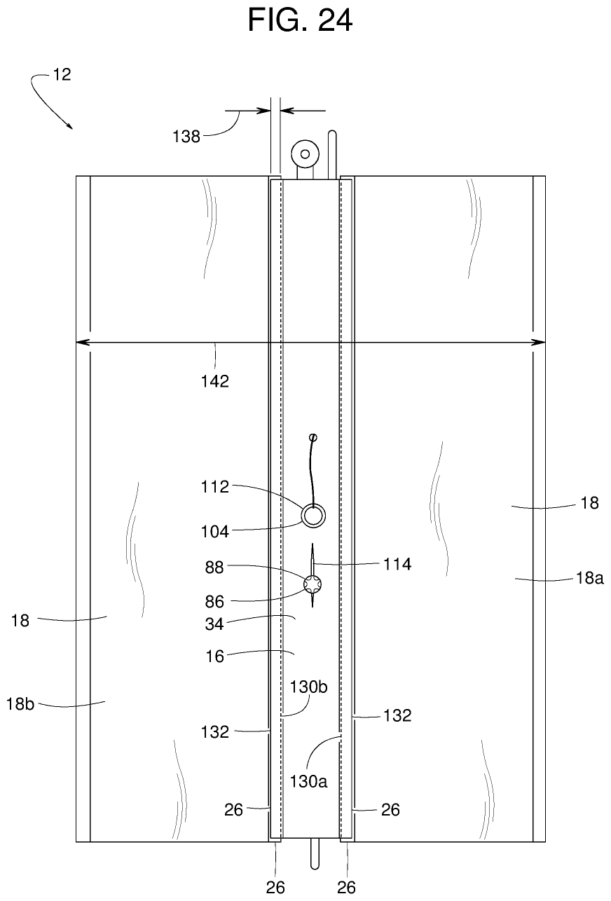

FIGS. 24-26 show examples of releasable fastener 26 having a plurality of configurations. FIG. 24, for example, shows releasable fastener 26 in a first configuration, where curtain edges 130a and 130b are substantially parallel to each other. As used herein, “substantially parallel” means that an edge, surface, or other structure or component (e.g., curtain edge 130a) is perfectly parallel relative to another edge, surface or other structure or component (e.g., edge 130b), or that an edge, surface, or other structure or component (e.g., edge 130a) is almost parallel (e.g., within 10 degrees of perfectly parallel) relative to another edge, surface, or other structure or component (e.g., edge 130b).

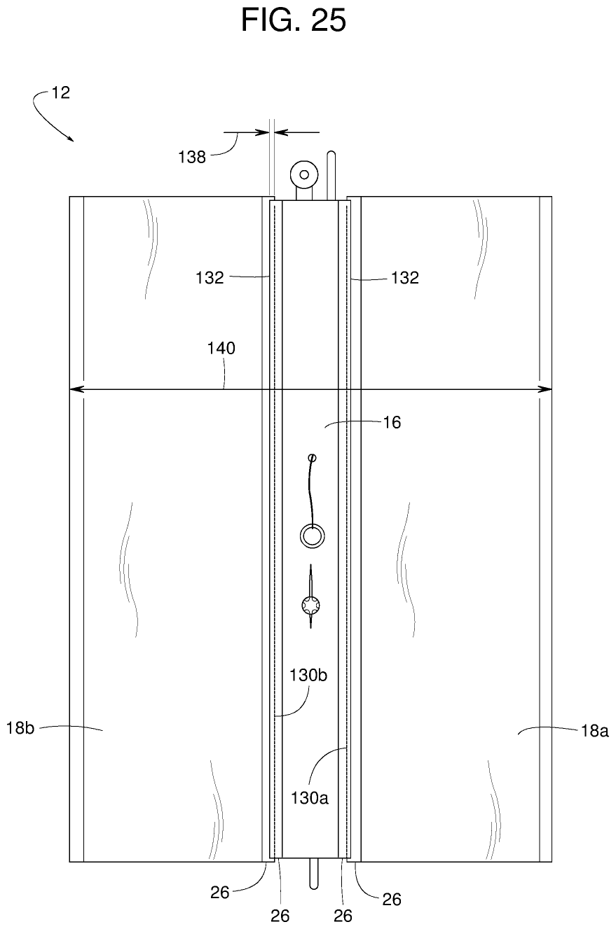

FIG. 25 shows releasable fastener 26 in a second configuration, where the mating parts of fastener 26 have less overlap 138 than in the first configuration of FIG. 24. Relatively less overlap 138 provides curtain assembly 12 with a greater overall width 140 (FIG. 25) than the curtain assembly's overall width 142 of FIG. 24. Providing curtain assembly 12 with an adjustable width enables the achievement of a precise desired width (e.g., 140 or 142). An adjustable width can also enable alignment of lock pins 38 and 36 and a particular respective discontinuity 50 and hole 42.

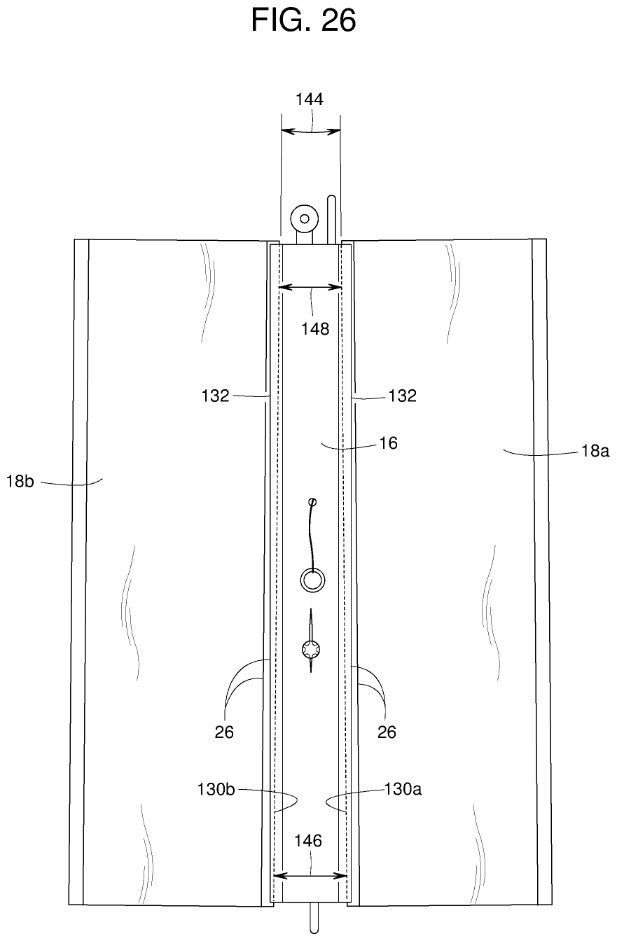

FIG. 26 shows releasable fastener 26 in yet another configuration with curtain edges 130a and 130b at an acute angle 144 to each other, rather than being substantially parallel (as shown in FIGS. 24 and 25). Due to angle 144, curtain edges 130a and 130b are spaced apart farther at one end of the edge than the other—distance 146, for example, is greater than distance 148. Being able to adjust the angular relationship of curtain edges 130a and 130b can enable compensation for dimensional variation or irregularities in curtain assembly 12, adjacent walls, floor 46, and/or track 15.

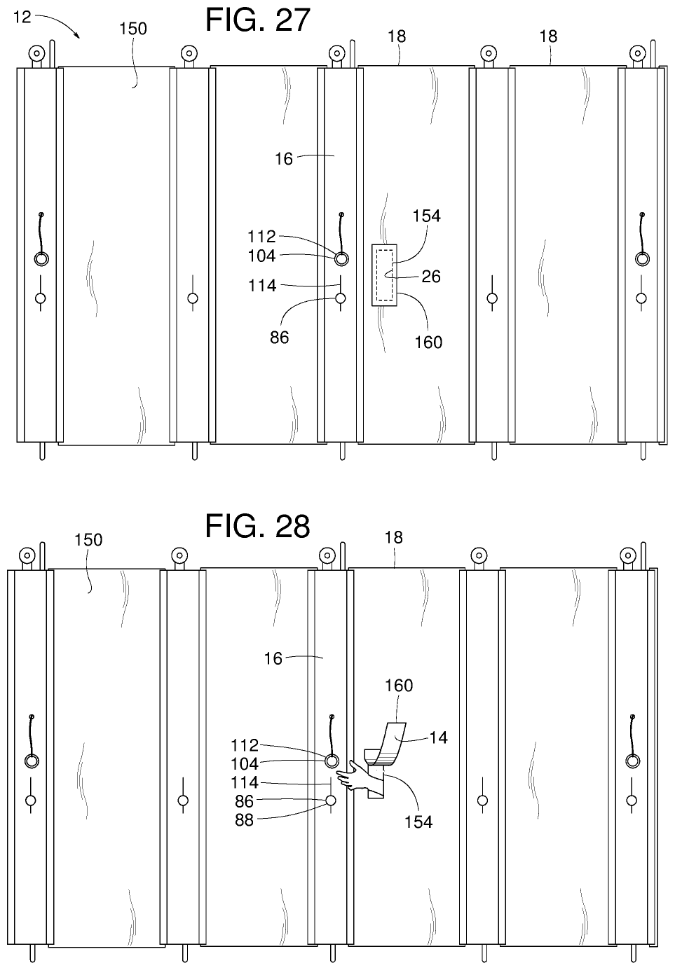

FIGS. 27 and 28 show upper and lower actuators 104 and 86 on a first side (e.g., back) 150 of curtain assembly 12. To access actuators 104 and 86 from the second (i.e. front, opposite) side 152 (FIG. 22), some examples of curtain assembly 12 include an opening 154 (e.g., an access opening, a hand-access opening) in curtain module 18. For example, a person on the first side 152 can access and operate actuator 104 and/or 86 on the second side 150 through opening 154.

In some examples, a cover 160 (e.g., a removable cover) can be used to close or seal opening 154 as shown in FIG. 27. Displacing or removing cover 160 allows access through the open 154 (e.g., enables a person to extend a hand or tool through opening 154) to operate actuators 104 and 86 (e.g., from a front side of the curtain module). When cover 160 is in a closed position (e.g., the cover 160 is in contact with the perimeter of opening 154), the cover 160 restricts or prevents air from passing through opening 154 and/or obstructs access to actuators 104 and 86 (e.g., from a front side of the curtain module). For function and appearance, some examples of cover 160 are made of the same sheet material 14 as curtain 24. In some examples, a releasable fastener 26 is positioned along the perimeter of cover 160 and opening 154 to connect cover 160 and curtain 24.

Although example curtains disclosed above have certain features, it should be understood that it is not necessary for a particular feature of one example curtain disclosed herein to be used exclusively with that example. Instead, any of the features of the example curtains described above and/or depicted in the drawings can be combined with any of the other example curtains disclosed herein, in addition to or in substitution for any of the other features of those examples. One example's features are not mutually exclusive to another example's features. Instead, the scope of this disclosure encompasses any combination of any of the features.

Although certain example methods, apparatus and articles of manufacture have been disclosed herein, the scope of coverage of this patent is not limited thereto. On the contrary, this patent covers all methods, apparatus, and articles of manufacture fairly falling within the scope of the claims of this patent.

1. A room partition, comprising:
a plurality of poles to be suspended from a track;
a curtain assembly having a plurality of sleeves through which the plurality of poles extends, the curtain assembly having a lowermost edge;
an upper lock pin attached to an upper end of a first pole of the plurality of poles and movable between a lock position and an unlock position relative to the first pole, the upper lock pin to be restrained when the upper lock pin is in the lock position, the upper lock pin to be unrestrained when the upper lock pin is in the unlock position; and
a lower lock pin attached to a lower end of the first pole and movable between a descended lock position and an elevated unlock position relative to the first pole, the lower lock pin to extend lower than the lowermost edge of the curtain assembly when the lower lock pin is in the descended lock position, the lower lock pin to be above the lowermost edge of the curtain assembly when the lower lock pin is in the elevated unlock position.

2. The room partition of claim 1, wherein the room partition is to be installed above a floor that defines a hole extending below an upper surface of the floor, the lower lock pin to extend into the hole when the lower lock pin is in the descended lock position, and the lower lock pin is to be positioned above the upper surface of the floor when the lower lock pin is in the elevated unlock position.

3. The room partition of claim 1, further including:
a plurality of upper lock pins that include the upper lock pin, wherein the plurality of upper lock pins is attached to the plurality of poles, the plurality of upper lock pins being of a first quantity; and
a plurality of lower lock pins that include the lower lock pin, wherein the plurality of lower lock pins is attached to the plurality of poles, the plurality of lower lock pins being of a second quantity, and the second quantity being greater than the first quantity.

4. The room partition of claim 1, further including:
an upper actuator operatively coupled to the upper lock pin to move the upper lock pin between the unlock position and the lock position; and
a lower actuator operatively coupled to the lower lock pin to move the lower lock pin between the elevated unlock position and the descended lock position, the lower actuator being movable relative to the upper actuator.

5. The room partition of claim 4, wherein the upper actuator includes a pliable elongate member extending through a sleeve of the plurality of sleeves.

6. The room partition of claim 1, further including a common actuator operatively coupled to the upper lock pin and the lower lock pin, the common actuator to move the upper lock pin between the unlock position and the lock position, and to move the lower lock pin between the elevated unlock position and the descended lock position, wherein upper lock pin and the lower lock pin move simultaneously in response to the common actuator.

7. The room partition of claim 1, wherein the curtain assembly includes a first side and a second side and defines an opening with a cover, the room partition further comprising:
an upper actuator at the second side of the curtain assembly, the upper actuator being operatively coupled to the upper lock pin to move the upper lock pin between the unlock position and the lock position, the opening to provide access through the curtain assembly to access the upper actuator from the first side of the curtain assembly when the cover is displaced from the opening, the cover to obstruct access to the upper actuator from the first side of the curtain assembly when the cover is positioned over the opening.

8. The room partition of claim 1, wherein the curtain assembly includes a first curtain module, a second curtain module, and a releasable fastener coupling a first edge of the first curtain module to a second edge of the second curtain module, the releasable fastener having a plurality of selective configurations including a first selected configuration and a second selected configuration, the curtain assembly having a greater overall width when the releasable fastener is in the first selected configuration than when the releasable fastener is in the second selected configuration.

9. The room partition of claim 1, wherein the curtain assembly includes a first curtain module, a second curtain module, and a releasable fastener coupling a first edge of the first curtain module to a second edge of the second curtain module, the releasable fastener having a plurality of selective configurations including a first configuration and a second configuration, the first edge and the second edge being substantially parallel when the releasable fastener is in the first configuration, and the first edge and the second edge being at an acute angle when the releasable fastener is in the second configuration.

10. The room partition of claim 1, further including a plurality of trolleys coupling the plurality of poles to the track.

11. The room partition of claim 1, wherein the curtain assembly includes a plurality of curtain modules and a plurality of sleeve modules interconnected in an alternating arrangement, the plurality of sleeve modules includes the plurality of sleeves through which the plurality of poles extend, the plurality of curtain modules includes a curtain module having a curtain width, the plurality of sleeve modules includes a sleeve module having a sleeve width that is less than the curtain width.

12. The room partition of claim 11, further including a plurality of releasable fasteners connecting the plurality of curtain modules and the plurality of sleeve modules in the alternating arrangement.

13. A room partition, comprising:
a plurality of curtain modules including a first curtain module and a second curtain module; and
a first sleeve module having a sleeve to receive a pole the sleeve to be more flexible than the pole, the first sleeve module includes a first restorable connector to at least one of connect or disconnect the sleeve and the first curtain module, the first sleeve module includes a second restorable connector to at least one of connect or disconnect the sleeve and the second curtain module.

14. The room partition of claim 13, further including:
an upper lock pin attached to an upper end of the pole, the upper lock pin being movable between a lock position and an unlock position, the upper lock pin to be restrained by a discontinuity formed in a track when the upper lock pin is in the lock position, the upper lock pin to release the discontinuity when the upper lock pin is in the unlock position.

15. The room partition of claim 14, further including:
a lower lock pin attached to a lower end of the pole, the lower lock pin being movable between a descended lock position and an elevated unlock position relative to the pole, the lower lock pin extending lower than a lowermost edge of at least one of the curtain modules when the lower lock pin is in the descended lock position, the lower lock pin being higher than the lowermost edge of the at least one of the curtain modules when the lower lock pin is in the elevated unlock position.

16. The room partition of claim 15, wherein the room partition is adapted for installation above a floor that defines a hole extending below an upper surface of the floor, the lower lock pin extends down into the hole when the lower lock pin is in the descended lock position, and the lower lock pin is above the upper surface of the floor when the lower lock pin is in the elevated unlock position.

17. The room partition of claim 14, further including:
an upper actuator operatively coupled to the upper lock pin to move the upper lock pin between the unlock position and the lock position, the upper actuator includes a pliable elongate member extending through the sleeve.

18. The room partition of claim 14, wherein the first curtain module includes a front side and a backside and defines an access opening, and a cover removably coupled to the first curtain and moveable between a closed position to cover the access opening and an open position to allow access through the access opening, and the room partition further comprising:
an upper actuator at the backside of the first curtain module, the upper actuator operatively coupled to the upper lock pin to move the upper lock pin between the unlock position and the lock position, the cover in the open position enables the access opening to provide a passageway through the first curtain module to enable access to the upper actuator from the front side of the first curtain module, the cover in the closed position to restrict access via the access opening to the upper actuator from the front side of the first curtain module.

19. The room partition of claim 13, further comprising:
a first curtain edge on the first curtain module, the first curtain edge being vertically elongate and overlapping the sleeve at the first restorable connection; and
a second curtain edge on the second curtain module, the second curtain edge being vertically elongate and overlapping the sleeve at the second restorable connector, the first restorable connector and the second restorable connector rendering the room partition selectively configurable to a first selected configuration and a second selected configuration, the first curtain edge being farther away from the second curtain edge when the room partition is in the first selected configuration than when the room partition is in the second selected configuration.

20. The room partition of claim 13, further comprising a trolley coupling the pole to a track.

21. The room partition of claim 13, wherein the first curtain module and the sleeve are comprised of substantially equivalent sheet material.

22. (canceled)

23. (canceled)

24. (canceled)

25. A room partition, comprising:
a track defining a plurality of discontinuities;
a plurality of poles suspended from the track;
a curtain assembly attached to the plurality of poles, the curtain assembly having a plurality of sleeves through which the plurality of poles at least partially extend;
an upper lock pin attached to an upper end of a first pole of the plurality of poles and being movable relative thereto; and
a lower lock pin attached to a lower end of the first pole and being movable relative thereto.
